(19) United States
(12) Patent Application Publication
(10) Pub. No.: US 2025/0139172 A1
(43) Pub. Date: May 1, 2025

(54) SERVERLESS NETWORK MONITORING

(71) Applicant: Capital One Services, LLC, McLean, VA (US)

(72) Inventor: Jose Mateo Ludena, Plano, TX (US)

(21) Appl. No.: 18/498,848

(22) Filed: Oct. 31, 2023

(51) Int. Cl. G06F 16/951

(52) U.S. Cl. CPC G06F 16/951

(57) ABSTRACT

Techniques for improved web scraping techniques may use a serverless computing environment including a serverless monitoring application having one or more anonymous functions, such as one or more Lambda functions. The serverless functions may monitor and scrape web sources. This lightweight solution provides monitoring and scraping functionality with improved efficiency with respect to resource utilization and energy consumption, including in scenarios where API access to the website is unavailable.

### FIELD OF USE

Aspects of the disclosure relate generally to network monitoring, including tracking and/or scraping webpage information using serverless cloud-based services.

### BACKGROUND

Conventional techniques for the retrieval of data from a web source may use an application done via application programming interface (API). In scenarios where an API is unavailable, web scraping may be used to access the web source and extract data from the web source. Conventional web scraping techniques involve software applications to be hosted and repeatedly executed. Such configurations require a dedicated computing resource to host and execute the scraping applications, resulting in increased expense and power consumption while reducing the availability of computing resources.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below. Corresponding apparatus, systems, and computer-readable media are also within the scope of the disclosure.

Aspects described herein generally improve web scraping techniques, including in scenarios where API access to the website is unavailable, by providing a serverless computing environment including a serverless monitoring application using one or more anonymous functions, such as one or more Lambda functions configured for the monitoring and scraping of web sources. The serverless monitoring application(s) offer a lightweight solution that provides monitoring and scraping functionality with improved efficiency with respect to resource utilization and energy consumption.

A system of one or more computers may be configured to perform particular operations or actions by virtue of having software, firmware, hardware, or a combination of them installed on the system that in operation causes or cause the system to perform the actions. One or more computer programs may be configured to perform particular operations or actions by virtue of including instructions that, when executed by data processing apparatus, cause the apparatus to perform the actions. As such, corresponding apparatus, systems, and computer-readable media are also within the scope of the disclosure.

These features, along with many others, are discussed in greater detail below.

### BRIEF DESCRIPTION OF THE DRAWINGS

The present disclosure is described by way of example and not limited in the accompanying figures in which like reference numerals indicate similar elements and in which:

FIG. 1 shows an example computing device in accordance with one or more aspects described herein.

FIG. 2 shows an example computing environment in which one or more aspects described herein may be implemented.

FIG. 3 shows a flowchart for a networking monitoring method according to one or more aspects of the disclosure.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. In addition, it is to be understood that the phraseology and terminology used herein are for the purpose of description and should not be regarded as limiting. Rather, the phrases and terms used herein are to be given their broadest interpretation and meaning.

By way of introduction, aspects discussed herein may relate to network monitoring techniques, including the monitoring and scraping of web sources using improved web scraping techniques without requiring API access to the web source. One or more aspects provide a serverless computing environment that may include a serverless monitoring application using one or more anonymous functions, such as one or more Lambda functions (e.g., Amazon Web Service (AWS) Lambda function), configured for the monitoring and scraping of web sources using value pair data, such as one or more value pair objects. The value pair object(s) may include one or more attributes, such as a resource locator of a webpage, a webpage element of the webpage, and/or one or more other attributes (e.g. threshold value). Two or more attributes of a respective value pair object may be in an associated relationship. For example, the resource locator of the webpage may be associated with a webpage element within the value pair object. Additionally, or alternatively, one or more value pair objects may be associated with one or more other value pair objects. Further, one or more aspects may include one or more browser interfaces (e.g., Selenium function) that may access the webpage to retrieve the webpage element based on a corresponding value pair object. In one or more aspects, the anonymous function(s) may include the browser interface(s) and control and use the browser interface(s) to perform the monitoring and scraping of web sources. The serverless monitoring and scraping functionality of one or more aspects provide improved efficiency and customization, while reducing resource utilization and energy consumption as compared to conventional techniques.

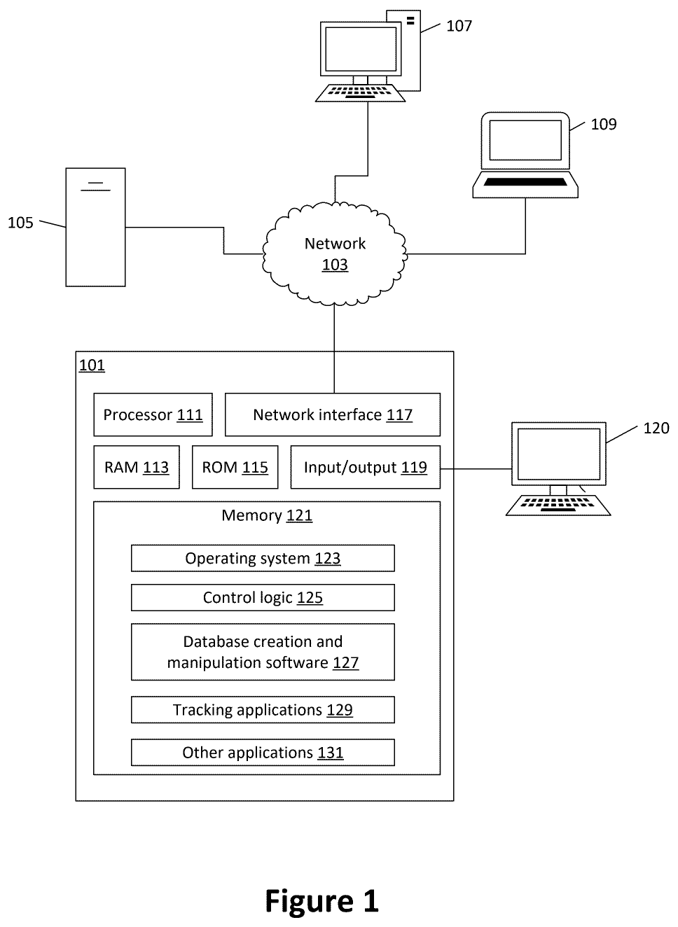

Before discussing the concepts of the disclosure in greater detail, however, several examples of a computing device that may be used in implementing and/or otherwise providing various aspects of the disclosure will first be discussed with respect to FIG. 1. FIG. 1 illustrates one example of a computing device 101 that may be used to implement one or more illustrative aspects discussed herein. For example, the computing device 101 may, in some embodiments, implement one or more aspects of the disclosure by reading and/or executing instructions and performing one or more actions based on the instructions. In some embodiments, the computing device 101 may represent, be incorporated in, and/or include various devices such as a desktop computer, a computer server, cloud server, a mobile device (e.g., a laptop computer, a tablet computer, a smart phone, any other types of mobile computing devices, and the like), and/or any other type of data processing device. In an exemplary embodiment, the computing device 101 may be embodied as a server (e.g. cloud server) adapted to execute one or more cloud-based application, such as one or more “serverless” applications, to perform aspect(s) of the disclosure.

The computing device 101 may, in some embodiments, operate in a networked environment. In others, the computing device 101 may operate in a standalone environment. As shown in FIG. 1, various network nodes 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topologies and may use one or more of a variety of different protocols, such as Ethernet. Devices 101, 105, 107, 109, and other devices (not shown) may be connected to one or more of the networks via twisted pair wires, coaxial cable, fiber optics, radio waves, or other communication media. Additionally, or alternatively, the computing device 101 and/or the network nodes 105, 107, and 109 may be a server hosting one or more databases. Databases may include, but are not limited to relational databases, non-relational databases, hierarchical databases, distributed databases, in-memory databases, flat file databases, XML databases, NoSQL databases, graph databases, and/or a combination thereof.

As seen in FIG. 1, the computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with database operations. Input/output 119 may include a variety of interface units and drives for reading, writing, displaying, and/or printing data or files. Input/output 119 may be coupled with a display such as display 120. Memory 121 may store software for configuring computing device 101 into a special purpose computing device in order to perform one or more of the various functions discussed herein. Memory 121 may store operating system software 123 for controlling overall operation of the computing device 101, control logic 125 for instructing the computing device 101 to perform aspects discussed herein, database creation and manipulation software 127, networking and tracking applications 129, and other application(s) 131. Control logic 125 may be incorporated in and may be a part of database creation and manipulation software 127. In other embodiments, the computing device 101 may include two or more of any and/or all of these components (e.g., two or more processors, two or more memories, etc.) and/or other components and/or subsystems not illustrated here.

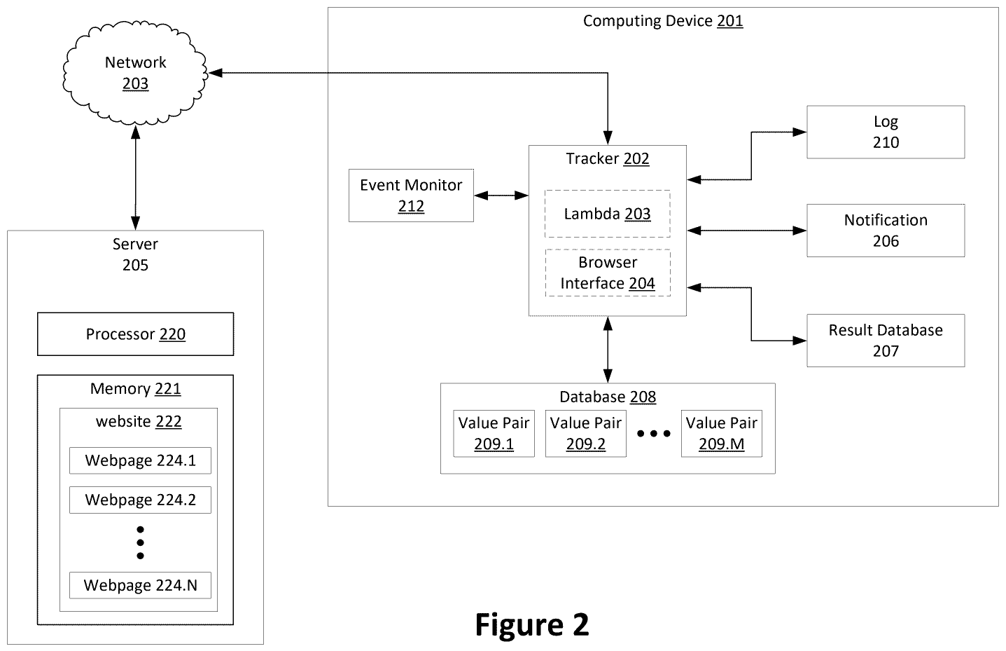

In an exemplary embodiment, the networking and tracking application(s) 129 may include one or more applications configured to perform network monitoring, such as webpage tracking and/or scraping. As discussed in more detail below with reference to FIG. 2, the networking and tracking application(s) 129 may be implemented in a serverless architecture, including being part of a virtual private cloud (VPC) of a cloud server. In this example, the computing device 101 may be a cloud server hosting one or more VPCs. Further, in an exemplary embodiment, the networking and tracking application(s) 129 may include one or more anonymous functions, such as one or more Lambda functions, configured to perform monitoring and/or scraping of web sources based on one or more value pair objects. The value pair object(s) may include one or more attributes, such as a resource locator of a webpage, a webpage element of the webpage, and/or one or more other attributes (e.g. threshold value). In one or more aspects, each attribute of the value pair object may include an identifier (e.g., a “key”) associated with the respective attribute. Two or more attributes of a respective value pair object may be in an associated relationship. For example, a resource locator (e.g., a Uniform Resource Locator (URL)) of a webpage may be in an associated relationship with a webpage element of the webpage. The browser interface(s) may be configured to access the webpage to retrieve the webpage element based on a corresponding value pair object. In an exemplary embodiment, the anonymous function(s) may include one or more browser interface(s) and control and use the browser interface(s) to perform the monitoring and scraping of web sources.

Devices 105, 107, 109 may have similar or different architecture as described with respect to the computing device 101. Those of skill in the art will appreciate that the functionality of the computing device 101 (or device 105, 107, 109) as described herein may be spread across multiple data processing devices, for example, to distribute processing load across multiple computers, to segregate transactions based on geographic location, user access level, quality of service (QoS), etc. For example, devices 101, 105, 107, 109, and others may operate in concert to provide parallel computing features in support of the operation of control logic 125, software 127, networking and tracking applications 129.

The data transferred to and from various computing devices may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. For example, a file-based integration scheme or a service-based integration scheme may be utilized for transmitting data between the various computing devices. Data may be transmitted using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and users to support input, extraction, and manipulation of data between the various computing devices in the system 100. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. For example, secure network appliances may include built-in features such as hardware-accelerated SSL and HTTPS, WS-Security, and/or firewalls. Such specialized hardware may be installed and configured in the system 100 in front of one or more computing devices such that any external devices may communicate directly with the specialized hardware.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) Python, JavaScript, or an equivalent thereof. The computer executable instructions may be stored on a computer readable medium such as a hard disk, optical disk, removable storage media, solid-state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product. Having discussed several examples of computing devices which may be used to implement some aspects as discussed further below, discussion will now turn to a method and serverless cloud-based architecture for network monitoring, including tracking and/or scraping webpage information.

FIG. 2 is a block diagram of an environment in which systems and/or methods described herein may be implemented. As shown in FIG. 2, the environment may include computing device 201 and server 205 connected by a network 203. The devices, servers, and network may be interconnected via wired connections, wireless connections, or a combination of wired and wireless connections.

The network 203 may include one or more wired and/or wireless networks. For example, network 204 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks. Network 204 may be represented as a single network, but may comprise combinations of other networks or subnetworks.

In practice, there may be additional devices and/or networks, fewer devices and/or networks, different devices and/or networks, or differently arranged devices and/or networks than those shown in FIG. 2. The number and arrangement of devices and networks shown in FIG. 2 are provided as an example, and although a single server 205 and one computing device 201 are illustrated, the disclosure is not limited thereto. Additionally, or alternatively, the server 205 and/or computing device 201 may be distributed across two or more virtual and/or physical devices. For example, the server 205 and/or computing device 201 may be implemented as multiple, distributed servers, such as in a cloud-based computing environment. Further, a set of devices of the environment may perform one or more functions described as being performed by another set of devices of the environment.

In an exemplary embodiment, server 205 may be a webserver hosting one or more websites 222 having one or more webpages 224. The server 205 may include a memory 221, such as a database or other storage. The memory 221 may store website data corresponding to one or more websites 222, and/or webpage data corresponding to one or more webpages 224. The memory 221 may store operating system software for controlling overall operation of the server 205, control logic for instructing the server 205 to perform aspects discussed herein, database creation and manipulation software, and/or one or more other applications. The server 205 may include processor 220 having one or more computer processing units (CPUs), graphical processing units (GPUs), and/or other processing units such as a processor adapted to perform computations associated with database operations.

In an exemplary embodiment, the computing device 201 may include a tracker 202, result database 207, notification application 206, web resource database 208, log 210, and/or event monitor 212. In an exemplary embodiment, the computing device 201 is a cloud server including a serverless architecture. In this example, the server 201 may host one or more VPCs that may include tracker 202, result database 207, notification application or module 206, web resource database 208, log 210, and/or event monitor 212.

The tracker 202 may be configured to perform network monitoring, website and/or webpage tracking, and/or website and/or webpage scraping. The tracker 202 may include one or more networking and tracking application(s) configured to perform the monitoring, tracking, and/or scraping functions of the tracker 202. The tracker 202 may be an embodiment of the networking and tracking applications 129 of FIG. 1 in one or more aspects.

As shown in FIG. 2, the tracker 202 may include one or more anonymous functions 203 (e.g., one or more Lambda functions) and/or a browser interface 204. In an exemplary embodiment, the anonymous function(s) 203 and browser interface 204 may cooperatively perform one or more functions of the tracker 202, such as the monitoring, tracking, and/or scraping functions. The anonymous function(s) 203 may include the browser interface 204 in one or more aspects.

In an exemplary embodiment, the anonymous function(s) 203 may be configured to perform one or more Lambda functions, and in these aspects, may be referred to as Lambda function. The anonymous function(s) 203 may be implemented by, for example, processor 111. Lambda functions may include functions that may be used by higher-order functions, such as those functions performed by tracker 202. Lambda functions may be used by other Lambda functions and/or used by non-Lambda functions to perform complex processing operations of the tracker 202.

The tracker 202 may communicate with the database 208 to access, retrieve, or otherwise receive one or more of the value pair objects 209 stored in the database 208. In one or more aspects, the database 208 may be implemented as, for example, an Amazon Web Service (AWS) database, such as a DynamoDB, or other serverless database.

The value pair object(s) 209 may include one or more attributes, such as a resource locator (e.g., a Uniform Resource Locator (URL)) of a webpage (e.g., webpage 224), a webpage element of the webpage, and/or one or more other attributes (e.g. threshold value). Two or more attributes of a respective value pair object 209 may be in an associated relationship. For example, the value pair object 209 may include a resource locator of the webpage (e.g., https://website.com), and a corresponding path and/or location of the webpage element within the webpage, where the corresponding path and/or location may be associated with the resource locator in the value pair object 209. Additionally, or alternatively, one or more value pair objects 209 may be associated with one or more other value pair objects. In one or aspects, the value pair object(s) 209 may include an identifier associated with one or more attributes (e.g., ID:<attribute value>). For example, the value pair object 209 including a URL for a webpage 224 may include an identifier “url” associated with the URL value of the webpage 224 (e.g., url:https://website.com).

In an exemplary embodiment, the value pair object 209 may include one or more nodes corresponding to the webpage element in an associated relationship to the resource locator. A node may include one or more pointers configured to locate the corresponding webpage element based on one or more attributes, properties, and/or characteristics of the webpage element. In an exemplary embodiment, the value pair 209 object may be implemented in a markup language (e.g. Extensible Markup Language (XML), HyperText Markup Language (HTML), etc.) that includes one or more path expressions to select nodes or node-sets in a markup language document or file. The path expression may be configured to directly point to a specific webpage element and/or tag attribute of the webpage without the need to manually iterate over an element list. In one or more aspects, the path expressions may use XPath (XML Path Language), which is an expression language designed to support the query or transformation of XML documents.

In an exemplary embodiment, the value pair objects 209 may be implemented as key-value pair objects stored in a data-interchange format, such as JavaScript Object Notation (JSON). Each of the key-value pairs may include a “key” associated with an “attribute value” that form the respective key-value pair. In this example, the “key” may identify and/or classify the corresponding attribute value. In one or more aspects, the key-value pair objects may include one or more key-value pairs that are stored as a JSON object. The key-value pairs of the JSON object may include the one or more key-value pairs, where the respective key and attribute value are separated by commas (e.g., “key1:value1”, “key2:value2”, “key3:value3”, . . . keyN:valueN), where the contents of the JSON object are surrounded by curly braces (e.g., “{ }”). For example, if the value pair object 209 includes a resource locator (e.g., URL) and a path expression of a webpage element of the webpage corresponding to the resource locator, the value pair object 209 may be formatted as: {url:[URL value], xpath:[path expression]}.

In an exemplary embodiment, the anonymous function(s) 203 may use the value pair(s) 209 to locate one or more webpage elements of the webpage or website associated with the resource locator (e.g., URL) of the webpage or website. For example, the anonymous function 203 may control the browser interface 204 to access the webpage or website based on the resource locator of the value pair object 209. The browser interface 204 may open a headless web browser and load the webpage or website associated with the resource locator, navigate to the associated webpage element based on one or more paths and/or one or more nodes (e.g., using pointer(s) within the node) of the value pair object 209, and then scrape or otherwise retrieve information or data of the located webpage element. In an exemplary embodiment, the browser interface 204 may include a Selenium function that is configured to open one or more headless web browsers, load the webpage or website associated with the resource locator, navigate to the associated webpage element based on one or more paths and/or one or more nodes (e.g., using pointer(s) within the node) of the value pair object 209, and then scrape or otherwise retrieve information or data of the located webpage element. The anonymous function 203 may then save the retrieved webpage element information in result database 207. In one or more aspects, the result database 207 may be implemented as a cloud object storage, such as an Amazon Simple Storage Service (S3) storage bucket.

Additionally, or alternatively, the anonymous function 203 may be configured to compare the retrieved webpage element information to other information (e.g. one or more other attributes), such as predetermined webpage element information, previously retrieved information (e.g., previous or historical webpage element information), one or more threshold values, or other information. For example, the webpage element may be a price listing, and may be compared with a previous price listing, target price, threshold price, etc (e.g., as another attribute of the value-pair object 209) such that the tracker 202 is configured to monitor a price listing on the webpage. In this example, the value-pair object 209 may include three value pairs: a resource locator (e.g., url:website.com), a webpage element (e.g., xpath:path), and price (e.g., targetprice:[$99.99]). In one or more exemplary embodiments, the anonymous function 203 may determine status information based on the comparison. The status information may correspond to whether the access and/or retrieval of the webpage element information was successful, a deviation (e.g., from a threshold value) of the retrieved webpage element information from the other information (e.g., previous webpage element information, historical webpage element information, etc.), a status of the tracker 202 and/or other component(s) of the computing device 201, a status of the server 205, and/or other status determinations.

Additionally, or alternatively, the anonymous function 203 may store the status information in log 210, which may maintain a log of the operational activities of the tracker 202 and/or one or more other components of the computing device 201. Additionally, or alternatively, the retrieved webpage element information may be stored in the log 210. In one or more aspects, the storage in the log 210 may provide storage redundancy of the webpage element information.

The anonymous function 203 may be configured to control the notification module 206 to generate a notification based on, for example, the comparison of the retrieved webpage element information to other information, status information, and/or other information. The notification module 206 may be referred to as alarm module 206. The generated notification may indicate the status of the tracker 202 and/or other component(s) of the computing device 201. For example, the notification may indicate whether the anonymous function 203 has completed one or more assigned tasks or operations, such as whether the anonymous function 203 has completed the scraping of each of the webpage elements associated with the value pair objects 209 stored in the database 208.

In an exemplary embodiment, the anonymous function 203 may be configured to perform one or more functions based on (e.g., in response to) an event notification, a request, and/or a command. The event monitor 212 may be configured to generate one or more even notifications and/or commands based on the occurrence of one or more events (e.g., a date and/or time, expiration of a timer, etc.) and/or monitored aspects of the server 201, server 205, and/or one or more other external devices. The events may include, for example, the occurrence of a specified time and/or date, an expiration of a timer, the occurrence of one or more statuses of one or components of the server 201 and/or server 205, or another event occurrence.

In an exemplary embodiment, the event monitor 212 may be configured to monitor one or more resources, applications, and/or functions of the server 201 (or one or more components therein) and/or server 205 (or one or more components therein). Additionally, or alternatively, the event monitor 212 may collect and track metrics (e.g., measurements of variable(s) for resource(s), application(s), and/or function(s), output (e.g., display) the metric(s), create one or more alarms configured to monitor the metric(s), generate one or more notifications (e.g., based on the metric tracking and/or other monitoring functions). In an exemplary embodiment, the event monitor 212 may (e.g., automatically) adapt one or more resources, applications, and/or functions of the server 201 (or one or more components therein) and/or server 205. The adaptation may be based on the metric tracking and/or other monitoring functions in one or more aspects. In one or more aspects, the event monitor 212 may be implemented using a serverless event monitor, such as AWS CloudWatch. In an exemplary embodiment, the notification module 206 and/or the log 201 may be included in the event monitor 212. In this example, the various components may be implemented using a serverless event monitor (e.g., CloudWatch).

In an exemplary embodiment, one or more operations/functions of the tracker 202 may be performed using a machine learning (ML) model. For example, the webpage element(s) and associated data and/or information may be scraped (e.g., by the anonymous function 203 and/or browser interface 204) using the ML model. The machine learning model may support a generative adversarial network, a bidirectional generative adversarial network, an adversarial autoencoder, transformer-based network (e.g., Seq2Seq), or an equivalent thereof. Additionally, or alternatively, the machine learning model may be a neural network, such as convolutional neural network (CNN), a recurrent neural network, a recursive neural network, a long short-term memory (LSTM), a gated recurrent unit (GRU), an unsupervised pretrained network, a space invariant artificial neural network, a generative adversarial network (GAN), or a consistent adversarial network (CAN), cyclic generative adversarial network (C-GAN), a deep convolutional GAN (DC-GAN), GAN interpolation (GAN-INT), GAN-CLS, a cyclic-CAN (e.g., C-CAN) or any equivalent thereof. Additionally, or alternatively, the one or more ML models may comprise one or more decision trees. In some instances, the one or more machine learning models may comprise a Hidden Markov Model. The ML model may be trained based on input data and/or output data of the tracker 202 (e.g., anonymous function 203 and/or browser interface 204), such as one or more resource locators, webpage elements, nodes and/or paths associated with webpage elements, data entered via the user interface (e.g., I/O 119, display 120), feedback provided by one or more users via the user interface, and/or or other information. The machine learning model may be trained using different training techniques, such as supervised training, unsupervised training, semi-supervised training back propagation, transfer learning, stochastic gradient descent, learning rate decay, dropout, max pooling, batch normalization, and/or any equivalent deep learning technique.

In an exemplary embodiment, the tracker 202 (e.g., anonymous function(s) 203) may be configured to determine one or more value pair objects 209, which may then be used by the tracker 202 to perform a subsequent network monitoring and/or webpage scraping according to one or more aspects described herein. In other aspects, the value pair object(s) 209 may be predetermined and provided to the server 201.

The determination of the value pair objects 209 may be based on one or more resource locators and one or more webpage elements of the webpage 224 and/or website 222 corresponding to the resource locator(s). For example, the anonymous function(s) 203 may access a website (e.g., using the browser interface 204) based on a resource locator (e.g., provided by a user). The anonymous function(s) 203 may then determine a webpage element of the accessed webpage/website based on one or more paths and/or one or more nodes (e.g., provided by the user) that identify the one or more webpage elements within the webpage or website associated with the resource locator. Additionally, or alternatively the anonymous function(s) 203 may determine one or more paths and/or one or more nodes based on a webpage element (e.g., identified by the user, such as based on a selection of the element via an input device (e.g., mouse)). The anonymous function(s) 203 may then determine the value pair object 209 based on the resource locator; webpage element; and/or nodes and/or paths. The anonymous function(s) 203 may store the determined value pair object(s) 209 in the database 208. In one or more aspects, the value pair object(s) 209 may be automatically determined by the anonymous function(s) 203. The automatic determination may be based on, for example, a resource locator provided to the anonymous function(s) 203. For example, the anonymous function(s) 203 may iteratively determine one or more value pair object(s) for one or more corresponding webpage elements on the webpage.

In an exemplary embodiment, the value pair object(s) 209 may be generated and/or adjusted using a ML model. The ML model may be same ML model or a different ML model that may be used to perform one or more operations/functions of the tracker 202.

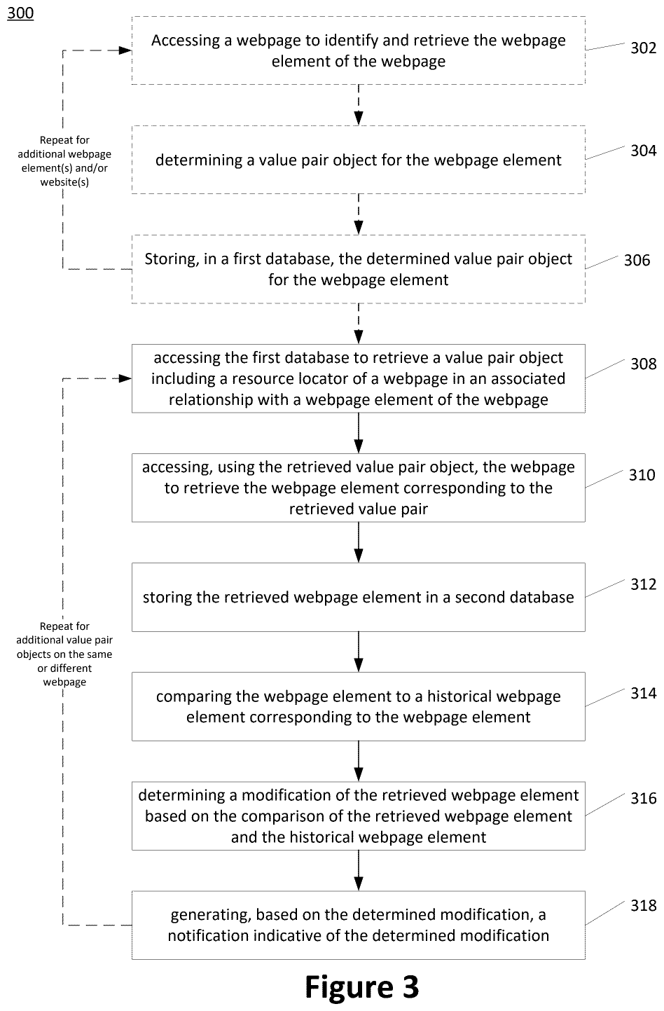

FIG. 3 is a flowchart for network monitoring method 300. Some or all of the operations of process 300 may be performed using one or more computing devices as described herein, such as server 201. Operations may be performed sequentially, at least partially concurrently, concurrently, or simultaneously. Additionally, or alternatively, the operation(s) may be iteratively performed (e.g., until one or more conditions is satisfied). The process 300 may include the creation of one or more values pair object s (e.g., operations 302-306) and the network monitoring and webpage element scraping using the created value pair object s (e.g., operations 308-318). In one or more aspects, the value pair object s may be predetermined, and the operations 302-306 may be omitted.

The process 300 begins as operation 302, where a webpage may be accessed to identify and retrieve a webpage element of the webpage. For example, the browser interface 204 (e.g., under control of the anonymous (e.g. Lambda) function 203) may access the webpage to identify and retrieve the webpage element of the webpage.

In an exemplary embodiment, the anonymous function(s) 203 may access a website (e.g., using the browser interface 204) based on a resource locator. The anonymous function(s) 203 may then determine a webpage element of the accessed webpage/website (e.g., based on one or more paths and/or one or more nodes that identify the one or more webpage elements within the webpage, based on a user selection or identification of the webpage element, etc.). In an exemplary embodiment, the anonymous function 203 may determine a webpage element of the accessed webpage/website based on one or more paths and/or one or more nodes (e.g., provided by the user) that identify the one or more webpage elements within the webpage or website associated with the resource locator. Additionally, or alternatively, the anonymous function 203 may determine one or more paths and/or one or more nodes based on a webpage element (e.g., identified by the user, such as based on a selection of the element via an input device (e.g., mouse)).

The process 300 transitions to operation 304, where a value pair object for the webpage element may be determined. For example, the anonymous function 203 may determine the value pair object 209 for the webpage element. In an exemplary embodiment, the anonymous function 203 may determine the value pair object 209 by associating the resource locator with the determined webpage element(s), one or more nodes associated with webpage element(s), one or more paths and/or pointers associated with the webpage element, attribute(s) of the webpage element(s), and/or other information associated with the webpage element.

The value pair object(s) 209 may each include a resource locator (e.g., a Uniform Resource Locator (URL)) of a webpage (e.g., webpage 224) in an associated relationship with a webpage element of the webpage. For example, the value pair object 209 may include a resource locator of the webpage, and a corresponding path and/or location of the webpage element within the webpage, where the corresponding path and/or location may be associated with the resource locator in the value pair object 209. In an exemplary embodiment, the value pair object 209 may include one or more nodes corresponding to the webpage element in an associated relationship to the resource locator. A node may include one or more pointers configured to locate the corresponding webpage element based on one or more attributes of the webpage element. In an exemplary embodiment, the value pair object 209 may include one or more path expressions to select nodes or node-sets in a markup language document or file. The path expression may be configured to directly point to a specific webpage element and/or tag attribute of the webpage without the need to manually iterate over an element list.

The process 300 transitions to operation 306, where the determined value pair object for the webpage element may be stored, for example, in a first database (e.g., database 208). For example, the anonymous function(s) 203 may store the determined value pair object(s) 209 in the database 208. In an exemplary embodiment, the operation 302-306 may be iteratively performed until a value pair object is determined for each desired webpage element of one or more webpages identified by a corresponding resource locator.

The process 300 transitions to operation 308, where the first database may be accessed to retrieve a value pair object 209. The value pair object 209 may include a resource locator of a webpage in an associated relationship with a webpage element of the webpage. For example, the tracker 202 (e.g., anonymous function 203) may communicate with the database 208 to access, retrieve, or otherwise receive one or more of the value pair objects 209 stored in the database 208.

The process 300 transitions to operation 310, where the webpage may be accessed, based on the retrieved value pair object, to retrieve the webpage element corresponding to the retrieved value pair object. In an exemplary embodiment, the anonymous function 203 may use to the value pair object 209 to locate one or more webpage elements of the webpage or website associated with the resource locator (e.g., URL) of the webpage or website. For example, the anonymous function 203 may control the browser interface 204 to access the webpage or website based on the resource locator of the value pair object 209. The browser interface 204 may open a headless web browser and load the webpage or website associated with the resource locator, navigate to the associated webpage element based on one or more paths and/or one or more nodes (e.g., using pointer(s) within the node) of the value pair object 209, and then scrape or otherwise retrieve information or data of the located webpage element.

The process 300 transitions to operation 312, where the retrieved webpage element may be stored in a second database. For example, the anonymous function 203 may save the retrieved webpage element information in result database 207. Additionally, or alternatively, the webpage element and/or information associated with the webpage element may be stored in log 210, which may be a component of the event monitor 212.

The process 300 transitions to operation 314, where the webpage element may be compared to a historical webpage element corresponding to the webpage element. For example, the anonymous function 203 may be configured to compare the retrieved webpage element information to other information, such as predetermined webpage element information, previously retrieved information (e.g., previous or historical webpage element information), one or more threshold values, or other information.

The process 300 transitions to operation 316, where a modification of the retrieved webpage element may be determined based on the comparison of the retrieved webpage element and the historical webpage element. For example, the anonymous function 203 may determine a deviation (e.g. from an expected value) and/or modification of the retrieved webpage element based on the comparison to the historical webpage element and/or a previous version of the retrieved webpage element. In one or more exemplary embodiments, the anonymous function 203 may determine status information based on the comparison. The status information may correspond to whether the access and/or retrieval of the webpage element information was successful, a deviation (e.g., from a threshold value) of the retrieved webpage element information from the other information (e.g., previous webpage element information, historical webpage element information, etc.), a status of the tracker 202 and/or other component(s) of the computing device 201, a status of the server 205, and/or other status determinations. Additionally, or alternatively, the anonymous function 203 may store the status information in log 210, which may maintain a log of the operational activities of the tracker 202 and/or one or more other components of the computing device 201. Additionally, or alternatively, the retrieved webpage element information may be stored in the log 210. In one or more aspects, the storage in the log 210 may provide storage redundancy of the webpage element information.

The process 300 transitions to operation 318, where a notification may be generated that is indicative of the determined modification. The notification may be generated based on the determined modification. For example, the notification module 206 may generate a notification (and send the notification to the user) based on the modification determined by the anonymous function 203. In an exemplary embodiment, the anonymous function 203 may be configured to control the notification module 206 to generate a notification based on, for example, the comparison of the retrieved webpage element information to other information, status information, and/or other information. Additionally, or alternatively, the generated notification may indicate the status of the tracker 202 and/or other component(s) of the computing device 201. For example, the notification may indicate whether the anonymous function 203 has completed one or more assigned tasks or operations, such as completed scraping each of the webpage elements associated with the value pair objects 209 stored in the database 208.

In an exemplary embodiment, the operation 308-318 may be iteratively performed until webpage elements for each stored value pair object 209 are scraped from their corresponding webpages using the value pair objects 209. This advantageously provides an automatic scraping of each of the webpage elements identified by the corresponding value pair objects 209. The iterations may omit one or operations in one or more aspect. For example, if the next webpage element is on the same webpage, accessing of the webpage by the anonymous function 203 may be omitted because it has already navigated to the webpage in the previous iteration.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, and the like. that perform particular tasks or implement particular abstract data types when executed by a processor in a computer or other device. The modules may be written in a source code programming language that is subsequently compiled for execution, or may be written in a scripting language such as (but not limited to) Python, Perl, or any other suitable scripting language. The computer executable instructions may be stored on a computer readable medium such as a hard disk, optical disk, removable storage media, solid-state memory, RAM, and the like. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a system, and/or a computer program product.

Although the present invention has been described in certain specific aspects, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. Any sequence of computer-implementable instructions described in this disclosure may be considered to be an “algorithm” as those instructions are intended to solve one or more classes of problems or to perform one or more computations. While various directional arrows are shown in the figures of this disclosure, the directional arrows are not intended to be limiting to the extent that bi-directional communications are excluded. Rather, the directional arrows are to show a general flow of steps and not the unidirectional movement of information. In the entire specification, when an element is referred to as “comprising” or “including” another element, the element should not be understood as excluding other elements so long as there is no special conflicting description, and the element may include at least one other element. In addition, the terms “unit” and “module”, for example, may refer to a component that exerts at least one function or operation, and may be realized in hardware or software, or may be realized by combination of hardware and software. In addition, terms such as “ . . . unit,” “ . . . module” described in the specification mean a unit for performing at least one function or operation, which may be implemented as hardware or software, or as a combination of hardware and software. Throughout the specification, expression “at least one of a, b, and c” may include ‘a only,’ ‘b only,’ ‘c only,’ ‘a and b,’ ‘a and c,’ ‘b and c,’ and/or ‘all of a, b, and c.’

It is noted that various connections between elements are discussed in the following description. It is noted that these connections are general and, unless specified otherwise, may be direct or indirect, and that the specification is not intended to be limiting in this respect. As described herein, thresholds are referred to as being “satisfied” to generally encompass situations involving thresholds above increasing values as well as encompass situations involving thresholds below decreasing values. The term “satisfied” is used with thresholds to address when values have passed a threshold and then approaching the threshold from an opposite side as using terms such as “greater than,” “greater than or equal to,” “less than,” and “less than or equal to” can add ambiguity where a value repeated crosses a threshold.

What is claimed is:

1. A computer-implemented method comprising:
accessing, using a Lambda function, a first database to retrieve, from the first database, a value pair object including a resource locator of a webpage in an associated relationship with a webpage element of the webpage;
accessing, by a browser interface and using the retrieved value pair object, the webpage to retrieve the webpage element corresponding to the retrieved value pair object;
storing, by the browser interface, the retrieved webpage element in a second database;
comparing, using the Lambda function, the webpage element to a historical webpage element corresponding to the webpage element;
determining, using the Lambda function, a modification of the retrieved webpage element based on the comparison of the retrieved webpage element and the historical webpage element; and
generating, based on the determined modification, a notification indicative of the determined modification.

2. The computer-implemented method of claim 1, further comprising, prior to retrieving the value pair object from the first database:
accessing, using the browser interface and under control of the Lambda function, the webpage to identify and retrieve the webpage element of the webpage;
determining, using the Lambda function, the value pair object for the webpage element; and
storing, in the first database, the determined value pair object for the webpage element.

3. The computer-implemented method of claim 1, wherein the value pair object comprises one or more nodes corresponding to the webpage element in an associated relationship to the resource locator.

4. The computer-implemented method of claim 3, wherein the one or more nodes comprise one or more pointers configured to locate the corresponding webpage element based on one or more attributes of the webpage element.

5. The computer-implemented method of claim 3, wherein the resource locator is a Uniform Resource Locator (URL) associated with the webpage.

6. The computer-implemented method of claim 1, further comprising:
accessing the first database to retrieve, from the first database, a second value pair object different from the value pair object and corresponding to a second webpage element of the webpage, the second webpage element being different from the webpage element;
accessing, by the browser interface and using the retrieved second value pair object, the webpage to retrieve the second webpage element corresponding to the retrieved second value pair object;
storing, by the browser interface, the retrieved second webpage element in the second database;
comparing the second webpage element to a second historical webpage element corresponding to the second webpage element;
determining a modification of the retrieved second webpage element based on the comparison of the retrieved second webpage element and the second historical webpage element; and
generating, based on the determined modification of the retrieved second webpage element, a second notification indicative of the determined modification of the retrieved second webpage element.

7. The computer-implemented method of claim 1, further comprising:
accessing the first database to retrieve, from the first database, a second value pair object different from the value pair object and corresponding to a second webpage element of a second webpage different from the webpage;
accessing, by the browser interface and using the retrieved second value pair object, the second webpage to retrieve the second webpage element corresponding to the retrieved second value pair object;
storing, by the browser interface, the retrieved second webpage element in the second database;
comparing the second webpage element to a second historical webpage element corresponding to the second webpage element; and
determining a modification of the retrieved second webpage element based on the comparison of the retrieved second webpage element and the second historical webpage element; and
generating, based on the determined modification of the retrieved second webpage element, a second notification indicative of the determined modification of the retrieved second webpage element.

8. The computer-implemented method of claim 1, further comprising controlling, using an event monitor, the Lambda function to access the first database and retrieve the value pair object.

9. The computer-implemented method of claim 8, further comprising receiving, by the Lambda function, a request from the event monitor, the Lambda function being configured to access the first database and retrieve the value pair object based on the received request.

10. The computer-implemented method of claim 1, wherein the Lambda function is further configured to control the browser interface to access the webpage to retrieve the webpage element.

11. The computer-implemented method of claim 8, further comprising storing, by the Lambda function, the retrieved webpage element in a log of the event monitor.

12. The computer-implemented method of claim 1, further comprising comparing a value of the retrieved webpage element to a threshold value and generating the notification based on a comparison of the value of the retrieved webpage element and the threshold value.

13. The computer-implemented method of claim 1, wherein the webpage element is a HyperText Markup Language (HTML) element.

14. A computing device comprising:
one or more processors; and
memory storing instructions that, when executed by the one or more processors, configure the computing device to:
access, using a Lambda function, a first database to retrieve, from the first database, a value pair object including a resource locator of a webpage in an associated relationship with a webpage element of the webpage;
cause, based on a request from the Lambda function, a browser interface to access, using the retrieved value pair object, the webpage to retrieve the webpage element corresponding to the retrieved value pair object;
store, by the browser interface, the retrieved webpage element in a second database;
compare, using the Lambda function, the webpage element to a historical webpage element corresponding to the webpage element;
determine, using the Lambda function, a modification of the retrieved webpage element based on the comparison of the retrieved webpage element and the historical webpage element; and
generate, using an event monitor and based on the determined modification, a notification corresponding to the determined modification.

15. The computing device claim 14, wherein the instructions, when executed by the one or more processors, further configure the computing device to request, using the event monitor and based on an event, the Lambda function to access the first database to retrieve the value pair object from the first database.

16. The computing device of claim 15, wherein the instructions, when executed by the one or more processors, further configure the computing device to store, using the Lambda function, the retrieved webpage element in a log of the event monitor.

17. The computing device of claim 14, wherein the instructions, when executed by the one or more processors, further configure the computing device to monitor, using the event monitor, the Lambda function to detect the determination of modification by the Lambda function, and generate, by the event monitor and based on the detected determination, the notification corresponding to the determined modification.

18. The computing device claim 14, wherein the Lambda function comprises the browser interface.

19. One or more non-transitory media storing instructions that, when executed, cause a computing device to:
access, using a Lambda function and based on a request from an event monitor, a first database to retrieve, from the first database, a value pair object corresponding to a webpage element of a webpage;
access, using a browser interface of the Lambda function, a browser interface to access, using the retrieved value pair object, the webpage to retrieve the webpage element corresponding to the retrieved value pair object;
store, by the browser interface, the retrieved webpage element in a second database; and
generate, using the event monitor, a notification corresponding to a status of the Lambda function.

20. The one or more non-transitory media of claim 19, wherein the value pair object comprises a resource locator of the webpage in an associated relationship with one or more nodes corresponding to the webpage element, the one or more nodes including one or more pointers configured to locate the corresponding webpage element based on one or more attributes of the webpage element.
